(19) United States
(12) Patent Application Publication
(10) Pub. No.: US 2025/0379620 A1
(43) Pub. Date: Dec. 11, 2025

(54) Automated Control of External Antennas for Docked Computing Devices

(71) Applicant: ZEBRA TECHNOLOGIES CORPORATION, Lincolnshire, IL (US)

(72) Inventors: Chu Pang Alex Ng, Markham (CA); Chris Chen, Taipei (TW); Manu Manirajan-Geetha, Hauppauge, NY (US); Jingyang Hu, Mississauga (CA); Constantin Adrian Sandu, Cambridge (CA)

(21) Appl. No.: 18/735,082

(22) Filed: Jun. 5, 2024

(51) Int. Cl. H04B 7/06; H01Q 3/24; H04B 7/08

(52) U.S. Cl. CPC H04B 7/0608; H01Q 3/24; H04B 7/0802

(57) ABSTRACT

A method in a computing device includes: detecting a connection between the computing device having a primary antenna and an accessory having an external antenna; selecting one of a plurality of antenna configurations based on an activity metric corresponding to a communication session with a network via the primary antenna; and activating at least one of the primary antenna or the external antenna according to the selected antenna configuration.

### BACKGROUND

A computing device, such as a tablet computer, can be mounted to a dock with features such as power delivery and an external antenna for wireless communications. Docking the device can lead to reduced wireless communications performance under certain conditions, however.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a wireless communications system.

FIG. 2 is a flowchart of a method of associating datagram loss with network segments.

FIG. 3 is a diagram illustrating an example set of antenna configurations.

FIG. 4 is a method of performing block 225 of the method of FIG. 2.

FIG. 5 is a diagram illustrating an example mapping of power tables to antenna configurations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a computing device includes: detecting a connection between the computing device having a primary antenna and an accessory having an external antenna; selecting one of a plurality of antenna configurations based on an activity metric corresponding to a communication session with a network via the primary antenna; and activating at least one of the primary antenna or the external antenna according to the selected antenna configuration.

Additional examples disclosed herein are directed to a computing device, comprising: a wireless communications interface; and a primary antenna; a processor configured to: detect a connection between the computing device and an accessory having an external antenna; select one of a plurality of antenna configurations based on an activity metric corresponding to a communication session with a network via the primary antenna; and activate at least one of the primary antenna or the external antenna according to the selected antenna configuration.

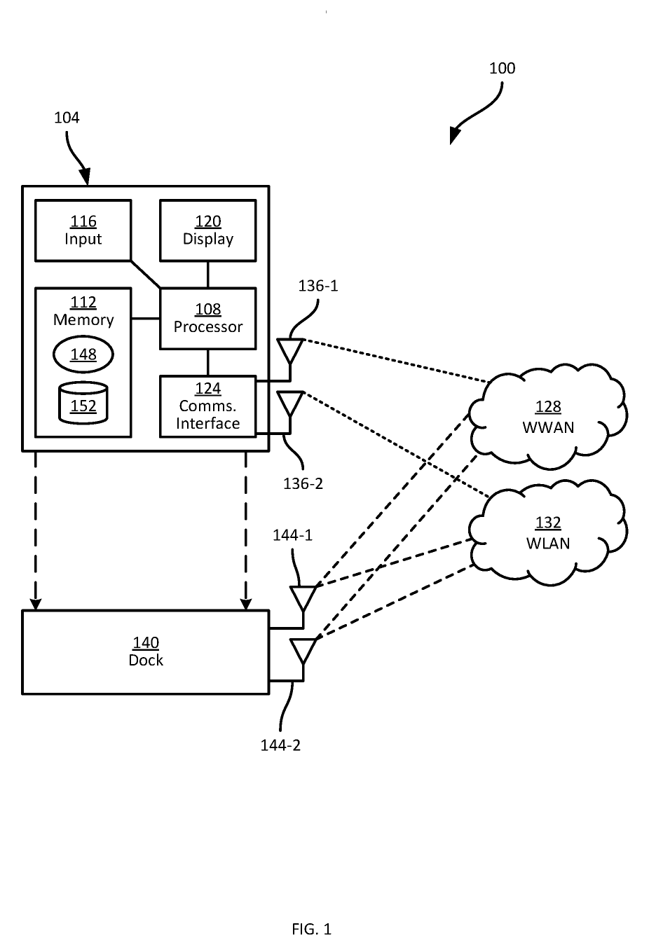

FIG. 1 illustrates a system 100 including a computing device 104, also referred to herein as the device 104. The device 104 can be implemented according to a variety of form factors, including a tablet computer, a laptop computer, a smart phone or other handheld computer, and the like. Certain internal components of the device 104 are shown in FIG. 1. The device 104 includes a processor 108, such as a central processing unit (CPU), graphics processing unit (GPU), application-specific integrated circuit (ASIC), or the like, communicatively coupled with a non-transitory computer-readable storage medium such as a memory 112, e.g., a combination of volatile memory elements (e.g., random access memory (RAM)) and non-volatile memory elements (e.g., flash memory or the like).

The device 104 can also include an input device 116, e.g., including any one or more of a touch screen, a keypad, a microphone, a camera, or the like. The device 104 can further including one or more output devices such as a display 120 (which can be integrated with the above-mentioned touch screen). The device 104 can also include other output devices such as a speaker or the like.

The device 104 also includes a communications interface 124, enabling the device 104 to establish connections with one or more networks. The system 100, in the illustrated example, includes a wireless wide area network (WWAN) 128 such as a cellular network (e.g., based on the 4G standard, the 5G standard, or any other suitable wide area radio access technologies). The system 100 also includes a wireless local area network (WLAN) 132 based on the Institute of Electrical and Electronics Engineers (IEEE) 802.11 family of standards (e.g., a Wi-Fi network). Various other types of networks can also be implemented in the system 100, and/or the system 100 can include more than one instance of a given type of network.

The device 104 can include one or more antennas, e.g., connected with the communications interface 124. In the illustrated example, the device 104 includes a first antenna 136-1, and a second antenna 136-2 (collectively referred to as the antennas 136, and generically referred to as an antenna 136; similar nomenclature may be used elsewhere herein for labels with numbered suffixes). The first antenna 136-1 can be controlled by the interface 124 to connect to the network 128 and/or other WWANs, while the second antenna 136-2 can be controlled by the interface 124 to connect to the network 132 and other WLANs. In other examples, the device 104 can include additional antennas 136, configured to connect to other types of networks, to establish short-range links, and the like. The antennas 136 may also be referred to as primary antennas 136 or internal antennas 136, as the antennas1 136 may be integrated with the device 104 (e.g., supported within or on a housing of the device 104).

The device 104 can be operated in a wide variety of environments. Some environments, e.g., including use of the device 104 within a vehicle such as a delivery van, a transport truck, or the like, may negatively affect the wireless communications performance of the device 104. For example, the cab of a truck may attenuate incoming and/or outgoing signals to and from the device 104 sufficiently to reduce connection throughput, increase latency due to frequent retransmissions, and/or drop connections with the networks 128 and 132. The system 100 can include a dock 140, e.g., mounted within the vehicle, configured to releasably engage the device 104. The dock 140 can supply power to the device 104, and may interconnect the device with other vehicle-mounted systems. In addition, the dock 140 can include, or be connected with, one or more external antennas 144. In this example, the dock 140 is connected with a first external antenna 144-1 and a second external antenna 144-2. Each of the antennas 144 can be controlled to connect to either of the networks 128 and 132. In some examples, both antennas 144 can be configured to connect to the same network (e.g., one of the network 128 and the network 132).

In some examples, the dock 140 can be implemented as a sled, e.g., a shell that can be coupled to a housing of the device 104 and includes one or more communication assemblies, such as a radio frequency identification (RFID) antenna controllable by the communications interface 124. The dock 140, or a sled as mentioned above, may be referred to collectively as an accessory.

The device 104 can be configured, as discussed in detail below, to detect when the device 104 has been engaged with the dock 140. When docked, the device 104 can control the antennas 144 instead of the antennas 136, to communicate via the networks 128 and/or 132. However, although the antennas 144 may be capable of mitigating the performance impacts of a vehicle cab or the like, the increased length of cabling or other connections (e.g., circuit board traces, ports, and the like) between the communications interface 124 and the antennas 144 may introduce additional performance impacts. For example, transmission power employed by the communications interface 124 to control the antennas 136 may result in insufficient signal strength when applied to the antennas 144, e.g., due to increased losses over the above-mentioned cabling and the like. When docked, the device 104 may therefore drop connections or suffer from reduced wireless performance.

In addition, there may be many possible configurations for the external antennas 144. In some systems, the selection of a configuration for the external antennas 144 may involve the receipt of input from a user of the device 104, which may increase the time involved in reconnecting with the networks 128 and/or 132, result in misconfigured external antennas 144, or the like.

As discussed below, the device 104 can be configured to automatically select from a set of predetermined antenna configurations when the device 104 is docked. Further, having selected an antenna configuration, the device 104 can alter transmission power for the external antennas to account for the increased losses mentioned above.

The memory 112 stores a plurality of computer-readable instructions in the form of applications, including in the illustrated example a communications application 148. Execution of the application 148 by the processor 108 configures the device 104 to perform automatic antenna configuration selection as noted above. The application 148 can also be implemented within the communications interface 124 in other examples. The memory 112 can also store a repository 152 that includes various configuration data for use during the execution of the application 148. The data contained in the repository 152 can also be stored in a plurality of repositories or other data structures in the memory 112 or otherwise accessible to the device 104, in other examples. The data in the repository 152 includes a plurality of antenna configurations, each specifying one or more network types (e.g., WLAN or WWAN), and for each specified network type, one or more antennas selected from the primary antennas 136 and the external antennas 144. A given antenna configuration, in other words, allocates one or more antennas to a given networking service for the device 104.

The repository 152 can also store one or more power tables, which can also be referred to as gain tables. As will be understood by those skilled in the art, a power table defines power levels to be applied at the output port(s) of the communications interface 124, for delivery to one or more antennas. For example, a power table may define gain values for each of a plurality of data rates (e.g., modulation and coding scheme, MCS, indices) and for each of a plurality of channels. That is, each pair of one data rate and one channel may be assigned a given power level, gain setting, or the like. In some examples, the power table can specify a minimum transmit power and a maximum transmit power for each of the above-mentioned pairs. The repository 152 can contain distinct power tables for different network types, in some examples.

As discussed below, the repository 152 can contain more than one transmit power value for a given pair of a channel and a data rate (or more than one maximum and minimum, in examples where both maximum and minimum transmit power levels are specified). For example, the repository 152 can contain a default power table for a given network type, as well as an auxiliary power table specifying higher transmission power levels than the default power table. The auxiliary power table can be used to control the antennas 144, while the default power table can be used to control the primary antennas 136. Each antenna configuration can be mapped to one or more power tables. In other examples, the higher transmission power levels used for the external antennas 144 need not be specified in complete auxiliary power tables, but can instead be specified fractional adjustments to the values of the default power tables, or the like.

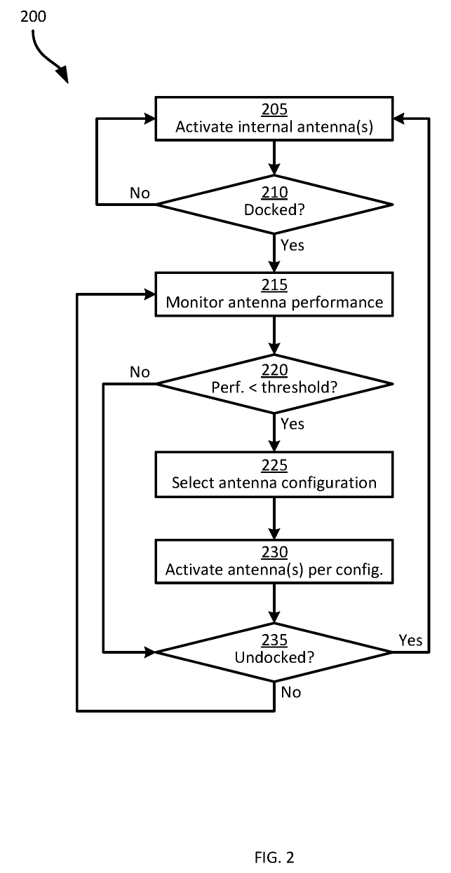

Turning to FIG. 2, a method 200 of automatic external antenna control is illustrated. The method 200 is described in conjunction with its performance by the device 104 via execution of the application 148 by the processor 108, but it will be understood that the method 200 can also be performed by a wide variety of other computing devices.

At block 205, the device 104 can be configured to activate either or both of the primary antennas 136, e.g., to connect with one or more of the networks 128 and 132. At block 210, the device 104 is configured to determine whether the device 104 has been docked (that is, engaged with the dock 140). The determination at block 210 can include monitoring a port or other connector of the device 104 and detecting a predefined signal on that port. For example, a connector of the device 104 configured to engage with a mating connector of the dock 140 can generate a low signal when undocked and a high signal when docked, or vice versa. The processor 108 can therefore determine whether the connector is engaged with the dock based on the signal observed at the connector. When the device 104 is engaged with the dock 140, the device 104 is connected with an external antenna assembly, e.g., including the external antennas 144. The dock 140 can include, for example, cabling or other internal hardware interconnecting the external antennas 144 with the above-mentioned connector.

When the determination at block 210 is negative, the device 104 can continue operating in a standalone mode, using the primary antennas 136 at block 205. When the determination at block 210 is affirmative, however, indicating that the external antennas 144 are available for use, the device 104 proceeds to block 215.

At block 215, the device 104 is configured to monitor at least one performance metric associated with the primary antenna(s) 136. The performance metric can be data throughput for active connections, a retransmission frequency, a received signal strength such as a reference signal received power (RSRP, e.g., in dBm), an indicator of received signal strength such as a received signal strength indicator (RSSI), or the like. For example, the device 104 can be configured to monitor an RSSI associated with the primary antenna 136-1, and an RSSI associated with the primary antenna 136-2. At block 220, the device 104 is configured to determine whether the antenna performance of any primary antenna 136 falls below a threshold, based on the information monitored at block 215. The device 104 can store one or more predetermined thresholds, such as a threshold for each antenna 136 (e.g., corresponding to each network type). The thresholds can be different for each network type (e.g., for each antenna 136). For example, a threshold signal strength of about -70 dBm can be applied for connections with WLAN networks, and a threshold signal strength of about -110 dBm can be applied for connections with WWAN networks.

When the determination at block 220 is affirmative for at least one primary antenna 136, the device 104 proceeds to block 225. In other words, if the performance of every primary antenna 136 monitored at block 215 exceeds the threshold(s) applied at block 220, then the determination at block 220 is negative, and the device 104 can continue using the primary antennas 136, thus avoiding potential interruptions to network connections resulting from switching to the external antennas 144.

At block 225, the device 104 is configured to select an antenna configuration from those defined in the repository 152. The selection of an antenna configuration at block 225 is based in part of the above-mentioned performance metrics, as a result of the determination at block 220. The selection of an antenna configuration at block 225 is also based on at least one activity metric corresponding to each connection established between a primary antenna 136 and a network 128 or 132.

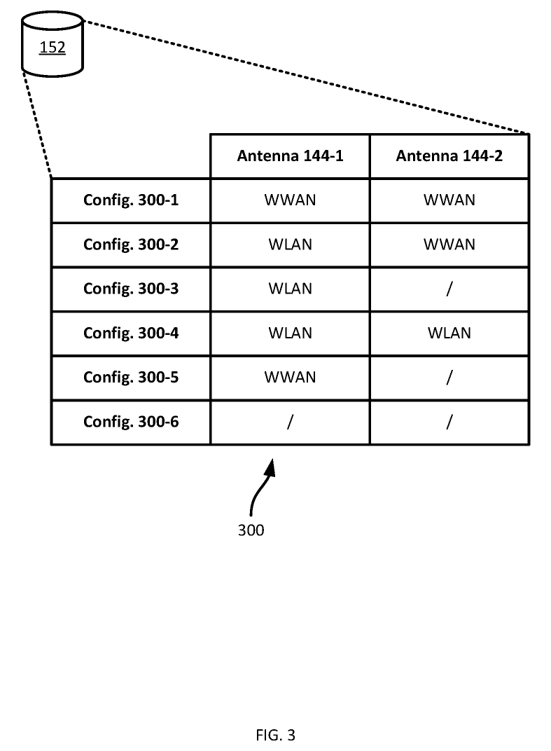

Turning to FIG. 3, an example set of antenna configurations 300 is shown, e.g., as stored in the repository 152. The configurations 300 need not have the format shown in FIG. 3, which is used solely for illustration. The configurations 300 include, in this example, six configuration records labelled 300-1, 300-2, 300-3, 300-4, 300-5, and 300-6. Each configuration 300 contains a network type indicator for each of the external antennas 144. As will be understood by those skilled in the art, the configurations 300 can include additional columns corresponding to further external antennas 144, e.g., when the external antenna assembly includes three or more external antennas 144. In some examples, the repository 152 can include a plurality of sets of configurations, e.g., if the device 104 is configured to engage with distinct dock models with different sets of external antennas 144.

As seen in FIG. 3, each configuration 300 assigns the external antenna 144-1 to a network type selected from WWAN and WLAN, or includes a blank assignment, indicating that under the corresponding configuration, that external antenna 144 is not used. The configuration 300-6, for example, does not assign a network type to either external antenna 144, and as a result when the configuration 300-6 is selected, the primary antennas 136 remain active, and neither external antenna 144 is used. The configuration 300-6 may be active at block 205, for example. When the configuration 300-1 is selected, both external antennas 144 are used for connection(s) with the WWAN network 128. Any WLAN connection is therefore implemented using the primary antenna 136-2 when the configuration 300-1 is active.

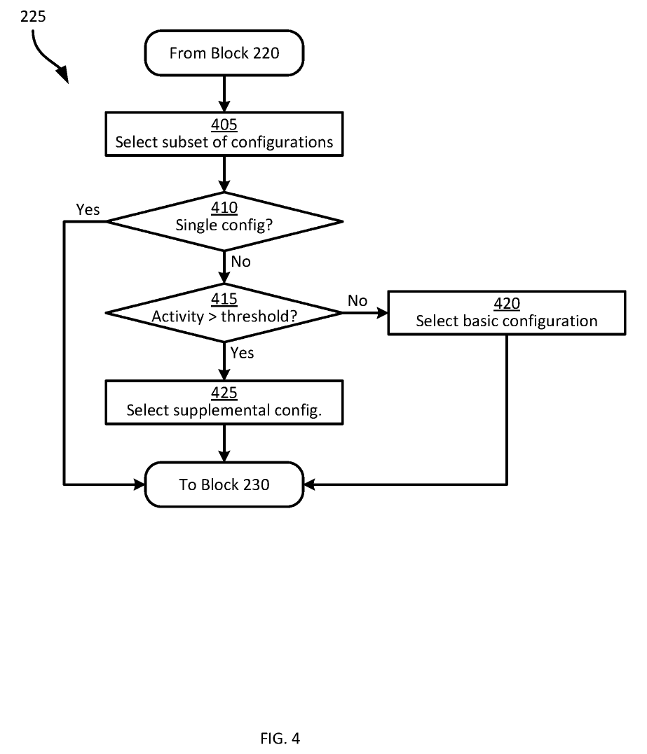

As will be apparent from FIG. 3, certain antenna configurations may be applicable to the same device state. For example, if the device 104 is connected to the WWAN 128, but not to the WLAN 132, the primary antenna 136-2 may be inactive (e.g., idle, or in some cases disabled). The configurations 300-1, 300-5, and 300-2 can each be applied to provide wide-area connections via the dock 140. FIG. 4 illustrates an example method for selecting an antenna configuration at block 225. Performance of the method of FIG. 4 configures the device 104 to select an antenna configuration from multiple candidate configurations.

The device 104 can, at block 405, select a subset of the configurations 300. In particular, the device 104 can select any configuration that assigns an external antenna 144 to a network type for which an affirmative determination was made at block 220. That is, if the determination at block 220 was affirmative for both the primary antennas 136-1 and 136-2, the device 104 is configured to select, at block 405, any configurations 300 that provide an external antenna 144 to both WLAN and WWAN connections. If the determination at block 220 was affirmative for the primary antenna 136-2, and negative for the primary antenna 136-1, the configurations 300-2, 300-3, and 300-4 may be selected at block 405.

At block 410, the device 104 is configured to determine whether the subset selected at block 405 contains a single configuration 300. When the determination at block 410 is affirmative, e.g., in the case above in which the determination at block 220 was affirmative for both primary antennas 136, the device 104 proceeds to block 230, having selected that single configuration 300.

When the determination at block 410 is negative, the device 104 proceeds to block 415. At block 415, the device 104 is configured to determine an activity metric corresponding to the connection(s) for which an affirmative determination was made at block 220. The device 104 is further configured to determine whether the activity metric satisfies a criterion, e.g., whether the activity metric meets a threshold. The activity metric can take a variety of forms. For example, the activity metric can include an indication of whether an active communication session is using the connection corresponding to the antenna for which an affirmative determination was made at block 220. The indication can be binary in some examples. In other examples, the indication can include a type of communication session, e.g., indicating whether the session is a real-time communication (e.g., voice session such as a voice or a video call), a file transfer operation, or the like. In other examples, the activity metric can include a throughput (e.g., an average number of bits per second) of the communication session. In further examples, the activity metric can include a number of frequency bands currently in use by the connection.

The criterion applied to the activity metric can be selected such that the determination at block 415 is affirmative for higher levels of activity. For example, the determination at block 415 can be affirmative if the connection under consideration is using two or more frequency bands, and/or has a throughput above a threshold, and/or is in use for a real-time communication session. When the determination at block 415 is negative, the device 104 proceeds to block 420. At block 420, the device 104 is configured to select a basic antenna configuration 300. A basic configuration 300 assigns one external antenna 144 to each network type with reduced performance at block 220, and does not assign external antennas 144 to any other network types. The basic configuration 300 also does not assign any additional external antennas 144 to a given network type.

For example, when the determination at block 220 is affirmative for the antenna 136-2 and negative for the antenna 136-1, the configurations 300-2, 300-3, and 300-4 may be selected at block 405. When the determination at block 415 is negative, e.g., because a single frequency band is in use by the antenna 136-2, and/or no real-time communication session is ongoing, or the like, the device 104 can select the configuration 300-3 as a basic configuration.

When the determination at block 415 is affirmative, the device 104 proceeds to block 425, and selects a supplemental configuration 300 that assigns one or more additional external antennas 144 to the connection for which an affirmative determination was made at block 220. For example, from the configurations 300-2, 300-3, and 300-4, the device 104 can select the configuration 300-4 if the connection between the antenna 136-2 and the WLAN 132 uses multiple frequency bands, is in use for a real-time communications session, or the like. The provision of an additional external antenna 144 to the connection with the WLAN 132 may improve communications performance.

Following selection of a configuration at block 420, 425, or block 410 (in which a single configuration 300 was retrieved at block 405), the device 104 proceeds to block 230 of the method 200. Returning to FIG. 2, at block 230 the device 104 is configured to activate one or more of the primary antennas 136 and the external antennas 144 according to the selected configuration 300. Activating an external antenna 144 can include directing signals output by the communications interface 124 to a port of the device 104 instead of to the corresponding antenna 136, for transmission to the external antenna 144 via the dock 140.

Connecting to the networks 128 and 132 via external antennas 144 may involve losing the connections previously established via the antennas 136. The device 104 can therefore be configured to suppress disconnection notifications from the communications interface 124 (e.g., from a network driver or the like) to applications executing at the device 104, for a predefined period of time (e.g., between one and fifteen seconds, though various other time periods can be used). Suppressing disconnection notifications may avoid the termination of application-level functions such as voice calls, file transfers, and the like, while connections are re-established via the external antennas 144.

Activating external antennas 144 can also include increasing a transmission power applied from the communications interface 124, for delivery to the external antennas 144. The transmission levels defined in the power tables mentioned above may be configured for regulatory compliance, e.g., to meet exposure limits. The transmission levels in a default power table, however, are determined based on the operation of the primary antennas 136, and therefore do not account for the losses incurred by longer signal paths between the communications interface 124 and the external antennas 144. Applying signals to the external antennas 144 according to a default power table may therefore result in lower than expected power levels actually emitted by the external antennas 144.

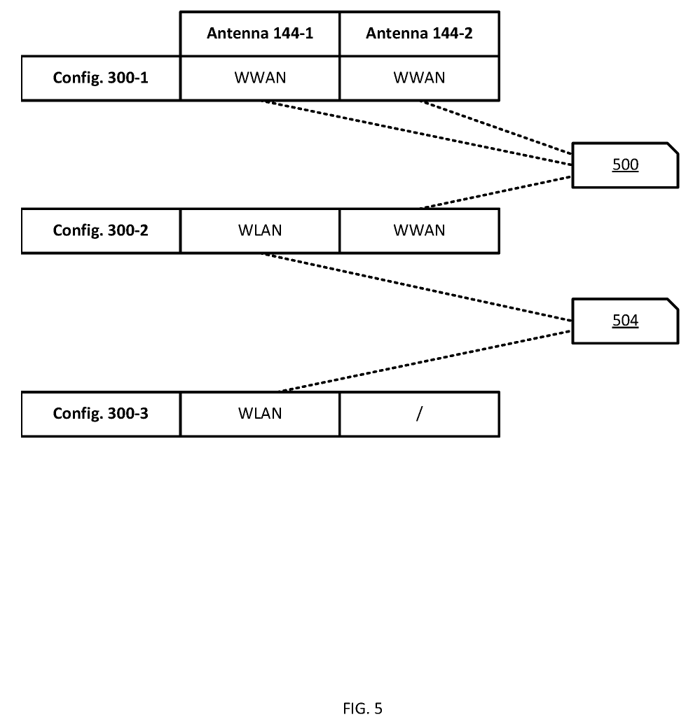

The device 104 can therefore maintain one or more auxiliary power tables, adjustment values, or the like. Each configuration 300 can be mapped to one or more auxiliary power tables. For example, referring to FIG. 5, three of the configurations 300 are shown, along with a first auxiliary power table 500 for WWAN connections, and a second auxiliary power table 504 for WLAN connections. Each of the auxiliary power tables can be mapped to configurations 300, as indicated by the dashed lines. The tables 500 and 504, as well as the mappings, can be maintained in the repository 152. The device 104 can be configured, at block 230, to retrieve any auxiliary power tables mapped to the configuration 300 selected at block 225, and apply at least a portion of the auxiliary power table to transmissions via the corresponding external antenna 144. In some examples, the device 104 can be configured to apply the settings of the auxiliary power table corresponding to a currently active channel, and to retain the default power settings for other channels. In other examples, the device 104 can apply an adjustment factor (e.g., increasing the settings in the default power table by 20%) rather than retrieve a distinct auxiliary power table.

Returning to FIG. 2, at block 235, the device 104 is configured to determine whether it has been undocked. When the determination at block 235 is affirmative, the device 104 is configured to return to block 205, and thus re-activate the primary antennas 136 (e.g., to select the configuration 300-6), and to revert to using the default power table(s). When the determination at block 235 is negative, the device 104 can return to block 215 and continue monitoring antenna performance. In some examples, further changes in antenna configuration can be implemented in response to changing performance metrics.

In some examples, the repository 152 can include antenna configurations that assign both internal antennas 136 and external antennas 144 to a given network type, e.g., to provide spatial diversity to connections implemented by the device 104. Spatial diversity may be provided to mitigate transitory signal fades (e.g., a reduction in received signal strength at a given antenna that may last from less than one second to about ten seconds). For example, the activity metric(s) at block 415 can be evaluated against multi-level criteria, e.g., leading to the selection of a configuration 300 assigning one additional external antenna 144 to a given network type if two frequency bands are in use for that network type, and assigning the additional external antenna 144 and the internal antenna 136 to that network type if three or more frequency bands are in use.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a computing device, the method comprising:
detecting a connection between the computing device having a primary antenna and an accessory having an external antenna;
selecting one of a plurality of antenna configurations based on an activity metric corresponding to a communication session with a network via the primary antenna; and
activating at least one of the primary antenna or the external antenna according to the selected antenna configuration.

2. The method of claim 1, wherein detecting the connection between the computing device and the accessory includes detecting that the device is mounted to a dock connected with the external antenna.

3. The method of claim 1, further comprising:
monitoring a performance metric associated with the primary antenna;
wherein selecting the one of the antenna configurations is further based on the performance metric.

4. The method of claim 3, further comprising:
determining that the performance metric is below a threshold; and
selecting the one of the antenna configurations, based on the activity metric, in response to the determination.

5. The method of claim 1, wherein selecting the one of the plurality of antenna configurations includes: determining whether the activity metric satisfies a criterion.

6. The method of claim 5, further comprising:
when the activity metric satisfies the criterion, selecting the one of the antenna configurations to allocate a first external antenna and a second external antenna to the connection with the network; and
when the activity metric does not satisfy the criterion, selecting the one of the antenna configurations to allocate only the first external antenna to the connection with the network.

7. The method of claim 5, wherein the activity metric includes at least one of:
(i) an indication of whether the communication session is a voice session, or
(ii) a number of frequency bands in use by the communication session.

8. The method of claim 1, further comprising:
increasing a transmission power applied by the computing device to the external antenna.

9. The method of claim 8, wherein increasing the transmission power includes:
retrieving an auxiliary gain table from a memory of the computing device; and
controlling the external antenna according to the auxiliary gain table.

10. The method of claim 1, wherein activating at least one of the primary antenna or the external antenna according to the selected antenna configuration includes activating the primary antenna and the external antenna to provide spatial diversity for the communication session.

11. A computing device, comprising:
a wireless communications interface; and
a primary antenna;
a processor configured to:
detect a connection between the computing device and an accessory having an external antenna;
select one of a plurality of antenna configurations based on an activity metric corresponding to a communication session with a network via the primary antenna; and
activate at least one of the primary antenna or the external antenna according to the selected antenna configuration.

12. The computing device of claim 11, wherein the processor is configured to detect the connection between the computing device and the accessory by detecting that the device is mounted to a dock connected with the external antenna.

13. The computing device of claim 11, wherein the processor is further configured to:
monitor a performance metric associated with the primary antenna; and
select the one of the antenna configurations based on the performance metric.

14. The computing device of claim 13, wherein the processor is configured to:
determine that the performance metric is below a threshold; and
select the one of the antenna configurations, based on the activity metric, in response to the determination.

15. The computing device of claim 11, wherein the processor is configured to select the one of the plurality of antenna configurations by:
determining whether the activity metric satisfies a criterion.

16. The computing device of claim 15, wherein the processor is configured to:
when the activity metric satisfies the criterion, select the one of the antenna configurations to allocate a first external antenna and a second external antenna to the connection with the network; and
when the activity metric does not satisfy the criterion, select the one of the antenna configurations to allocate only the first external antenna to the connection with the network.

17. The computing device of claim 15, wherein the activity metric includes at least one of:
(i) an indication of whether the communication session is a voice session, or
(ii) a number of frequency bands in use by the communication session.

18. The computing device of claim 11, wherein the processor is configured to:
increase a transmission power applied by the computing device to the external antenna.

19. The computing device of claim 18, wherein the processor is configured to increase the transmission power by:
retrieving an auxiliary gain table from a memory of the computing device; and
controlling the external antenna according to the auxiliary gain table.

20. The computing device of claim 11, wherein the processor is configured to activate at least one of the primary antenna or the external antenna according to the selected antenna configuration by activating the primary antenna and the external antenna to provide spatial diversity for the communication session.
